(19) United States
(12) Patent Application Publication
(10) Pub. No.: US 2008/0226176 A1
(43) Pub. Date: Sep. 18, 2008

(54) IMAGE DISPLAYING METHODS AND SYSTEMS

(75) Inventors: Shu-Wen Teng, Taipei City (TW); Yu-Chung Chang, Hsinchu Hsien (TW); Albert Achuan Hsueh, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/687,045

(22) Filed: Mar. 16, 2007

(51) Int. Cl. G09G 5/395

(52) U.S. Cl. 382/193

(57) ABSTRACT

A reading/writing method for displaying an input image. M data sets of the input image are written into a first memory buffer at a first line scanning path. The M data sets are then read from the first memory buffer at a zig-zag scanning path to serve as a read-out sequence of data sets. The read-out sequence of data sets is written into to a second memory buffer at the zig-zag scanning path. The read-out sequence of data sets is read from the second memory buffer at a second line scanning path to display the input image in a rotating form.

### BACKGROUND OF THE INVENTION

1. Field of the Invention

The invention relates to a data reading method, and more particularly to a data reading method applied in a memory buffer and reading data at a zig-zag scanning path.

2. Description of the Related Art

Electronic systems with display function decode an input image via a video decoder to generate a plurality of image data sets or directly receive a plurality of image data sets referred to as an input image by an image sensor. The image data sets can be written into a display device, such as a liquid crystal display (LCD) device, within the electronic systems in a horizontal scan direction to display an output image. The image data sets from the video decoder or the image sensor are first stored in an image buffer. The image data sets are read from the image buffer and stored in a display buffer used for image display.

Some electronic systems with display function, such as mobile phones, comprise a vertical display panel. In some applications of a mobile phone, an input image is rotated to form an output image, and then the output image is displayed on the display panel. For example, when a mobile phone acquires an input image in a horizontal direction, the input image is rotated by 90 degrees (90°) to display an output image on a vertical display panel to provide a better viewing angle.

The rotation of images can be achieved by adjusting the reading or writing sequence of a source buffer and a destination buffer. As shown in FIG. 1, assuming that the reading sequence of a source buffer (S) is fixed in a horizontal direction, eight kinds of image rotation can be obtained by changing the writing direction and the starting point of a destination buffer (D), as shown in FIGS. 2a-2h. In FIG. 2a, the image is not rotated; in FIG. 2b, the image is rotated by 90°; in FIG. 2c, the image is flipped horizontally; in FIG. 2d, the image is flipped vertically; in FIG. 2e, the image is rotated by 180°; in FIG. 2f, the image is rotated by 270°; in FIG. 2g, the image is rotated by 90° and flipped vertically; in FIG. 2h, the image is rotated by 270° and flipped vertically.

FIG. 3 depicts the 90° rotation of images in a conventional electronic system with display function. Referring to FIG. 3, a plurality of image data sets of an input image are written into an image buffer 30 in a horizontal scan direction, represented by arrows 31. Due to the 90° rotation, the image data sets have to be read from the image buffer 30 in a vertical scan direction, represented by arrows 32. The image data sets from the image buffer 30 are then written into a display buffer 33 in the horizontal scan direction, represented by arrows 34. To display an output image on a display panel, such as an LCD panel, the image data sets in the display buffer 33 are read in the horizontal scan direction, represented by arrows 35.

According to FIG. 3, the arrows 31 and arrows 32 are interlaced. To avoid tearing effect, the writing and reading operation cannot be performed at the same time. To the worse, it may take double time to complete both the data reading and writing from the image buffer 30. Thus, in order to avoid the tearing effect without sacrifice time, in the conventional approach, two image buffers 40a and 40b are adopted, as shown in FIG. 4. By this way, the image writing and reading operation can be performed simultaneously at the image buffers 40a and 40b. Using double buffers however would highly increase the cost of the electronic systems. Therefore, it is desired to have another time and cost efficient solution to handle this reading and writing problem.

### BRIEF SUMMARY OF THE INVENTION

Reading methods for a memory buffer are provided. An exemplary embodiment of a reading method for a memory buffer comprises a pixel array region comprises: writing M data sets into a memory buffer at a line scanning path, wherein the memory buffer is of H horizontal lines and L vertical lines; and reading the M data sets from the memory buffer at a zig-zag scanning path.

Reading/writing methods are provided. An exemplary embodiment of a reading/writing method is used to display an input image and comprises: writing M data sets of the input image into a first memory buffer at a first line scanning path, wherein the first memory buffer is of H horizontal lines and L vertical lines; reading the M data sets from the first memory buffer at a zig-zag scanning path to serve as a read-out sequence of data sets; writing the read-out sequence of data sets into to a second memory buffer at the zig-zag scanning path; and reading the read-out sequence of data sets from the second memory buffer at a second line scanning path to display the input image.

Electronic systems with display function are provided. An exemplary embodiment of an electronic system displays an output image according an input image and comprises a data generator, a first memory buffer, a first buffer controller, and a display module. The data generator generates M data sets of the input image. The first memory buffer is of H horizontal lines and L vertical lines, which stores the M data sets from the data generator. The M data sets are written into the first memory buffer at a first line scanning path. The first buffer controller reads the M data sets from the first memory buffer at a first zig-zag scanning path to serve as a read-out sequence of data sets. The display module receives the read-out sequence of data sets from the first controller and displays the input image according to the read-out sequence of data sets.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a reading direction of a source buffer;

FIGS. 2a-2h shows a writing direction and a starting point of a destination buffer;

FIGS. 3a and 3b depicts the 90° rotation of images in a conventional electronic system with display function;

FIG. 3 depicts the 90° rotation of images in a conventional electronic system with display function;

FIG. 4 depicts the 90° rotation of images in another conventional electronic system with display function;

FIG. 5 depicts an exemplary embodiment of an electronic system with display function;

FIG. 6 depicts the 90° rotation of an input image according to an exemplary embodiment;

FIGS. 7a-7c depicts an exemplary embodiment of an image buffer;

FIG. 8 depicts that the operation of writing at a horizontal scanning path meets the operation of reading at a zig-zag scanning path in the Nth horizontal line;

FIG. 9 depicts the determination of the predetermined number of the data sets when L is smaller than H; and

FIG. 10 depicts the determination of the predetermined number of the data sets when L is larger than H

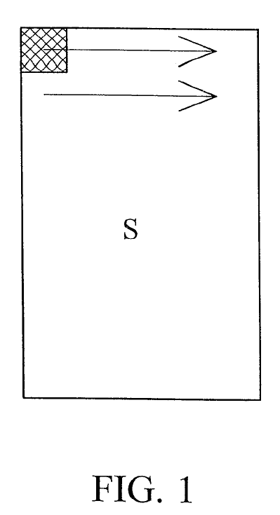

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

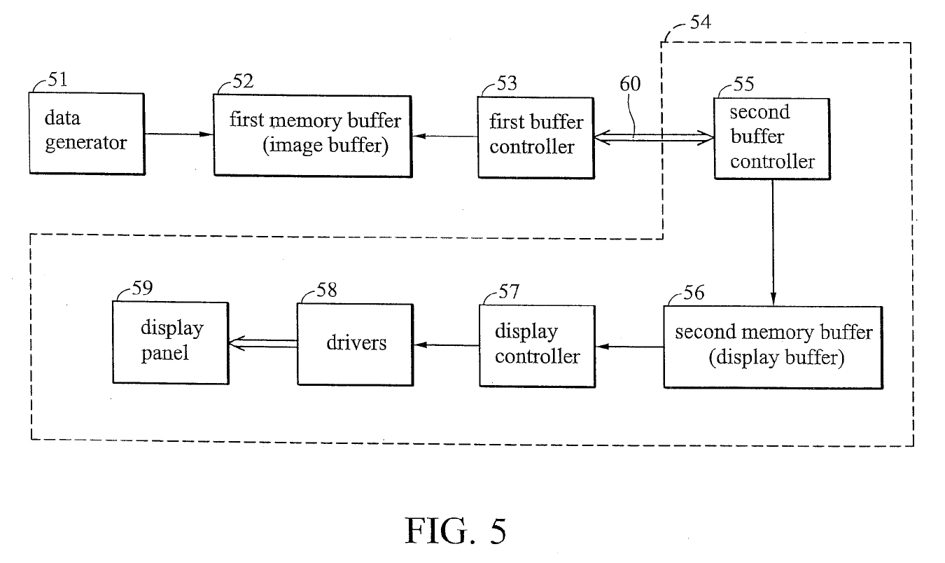

Electronic systems with display function are provided. In an exemplary embodiment of an electronic system with display function in FIG. 5, an electronic system 5 comprises a data generator 51, a first memory buffer 52, a first buffer controller 53, and a display module 54. The display module 54 is a liquid crystal display (LCD) module, and the LCD module 54 comprises a second buffer controller 55, a second memory buffer 56, a display controller 57, drivers 58, and a display panel 59. The drivers 58 comprise a data driver and a scan driver (not shown).

In some embodiments, the first memory buffer 52 is an image buffer, and the second memory buffer 56 is a display buffer. The data generator 51 can be a video decoder or an image sensor. If the data generator 51 is a video decoder, the video decoder 51 decodes an input image to generate a plurality of image data sets. If the data generator 51 is an image sensor, the image sensor 51 receives a plurality of image data sets referred to as an input image.

In following description, the electronic system 5 displaying an output image rotated by 90° is given as an example.

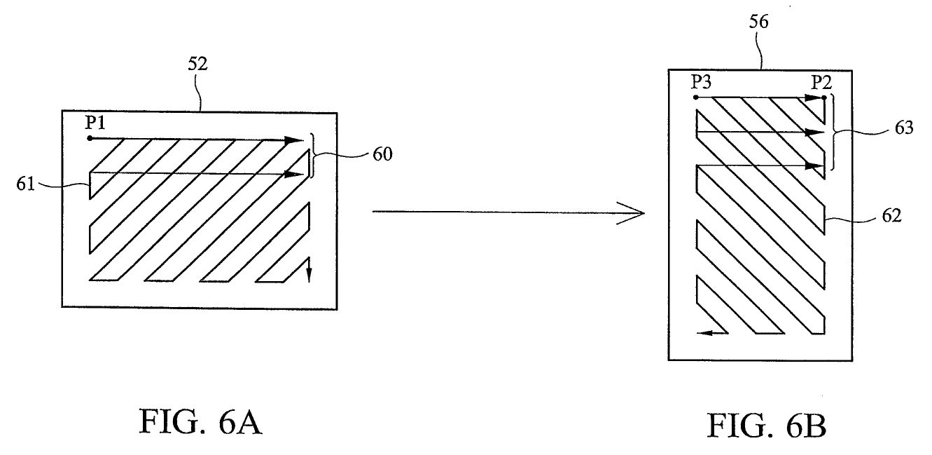

It is assumed that the data generator 51 generates M data sets of an input image of a frame. The data generator 51 writes the M data into the image buffer 52 at a first line scanning path from a starting point P1. The first line scanning path can be implemented in a horizontal direction or a vertical direction. The first line scanning path is implemented in a horizontal direction represented by arrows 60 in FIG. 6. The first buffer controller 53 reads the M data sets from the first memory buffer at a zig-zag scanning path represented by an arrow 61 in FIG. 6 from the starting point P1 to serve as a read-out sequence of data sets. The first buffer controller 53 transmits the read-out sequence of data sets to the second buffer controller 55 through an interface 50.

The second buffer controller 55 then writes the read-out sequence of data sets into to the display buffer 56 at the zig-zag scanning path represented by arrows 62 in FIG. 6 from a starting point P2. Note that to reach the 90° rotation, the starting point P2 is in the right-upper corner of the display buffer 56. The display controller 57 reads the read-out sequence of data sets from the display buffer 56 at a second line scanning path. In this embodiment, because the display module 54 is an LCD module, the second line scanning path is implemented in a horizontal direction represented by an arrow 63 from a starting point P3. The display controller 57 generates a plurality of control signals and transmits the control signals and the read-out sequence of data sets to the drivers 58. According to the control signals and the read-out sequence of data sets, the drivers 58 drive the display panel 59 to display an output image.

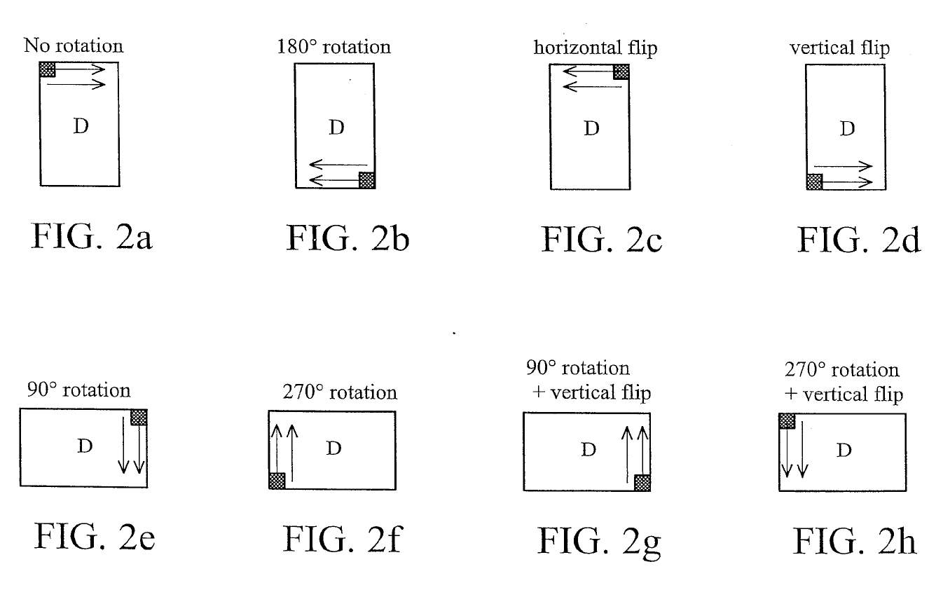

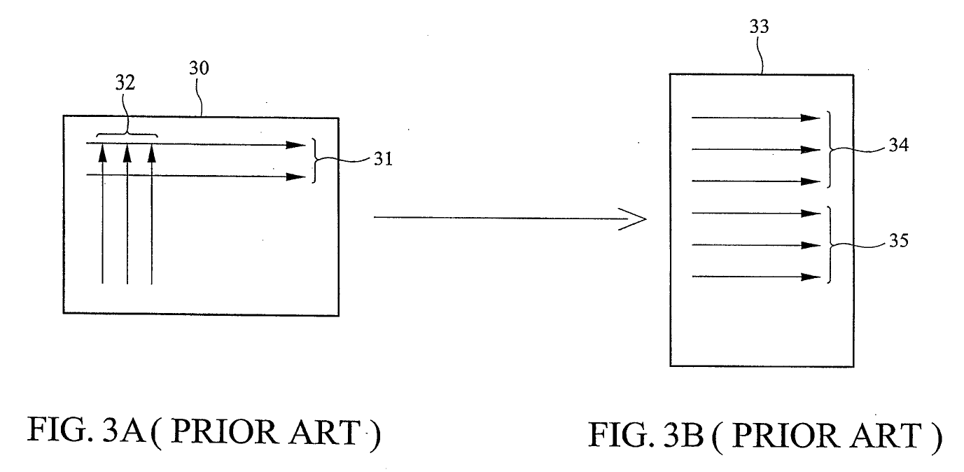

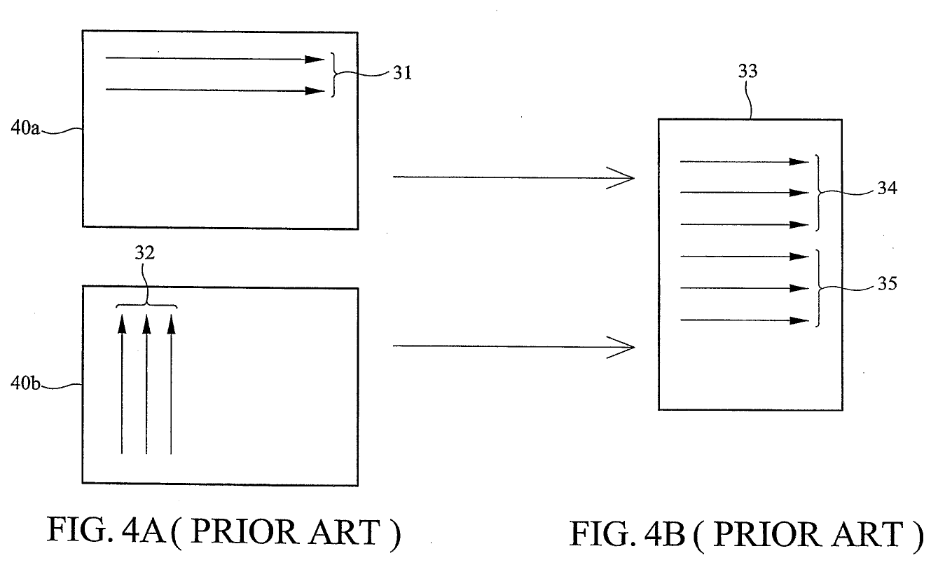

The 90° rotation is given as an example in FIG. 6. Other angles of input image rotation, as shown in FIGS. 2a-2d and 2f-2h, can also use the above zig-zag scanning path. Note that in the cases as shown in FIGS. 2b, 2d, 2f, and 2h, the starting point of the zig-zag scanning path 62 is at the bottom of the display buffer 56. Moreover, the first buffer controller 53 and the second buffer controller 55 can be integrated to be one controller, and the interface 50 is this omitted.

In some embodiments, after at least M/2 data sets among the M data sets are written into the image buffer 52, the first buffer controller 53 begins to read the data sets from the image buffer 52 from the starting point P1. The tearing effect is thus eliminated. Similarly, after at least M/2 data sets among the M data sets are written into the display buffer 56, the display controller 57 begins to read the data sets from the display buffer 56 from the starting point P3.

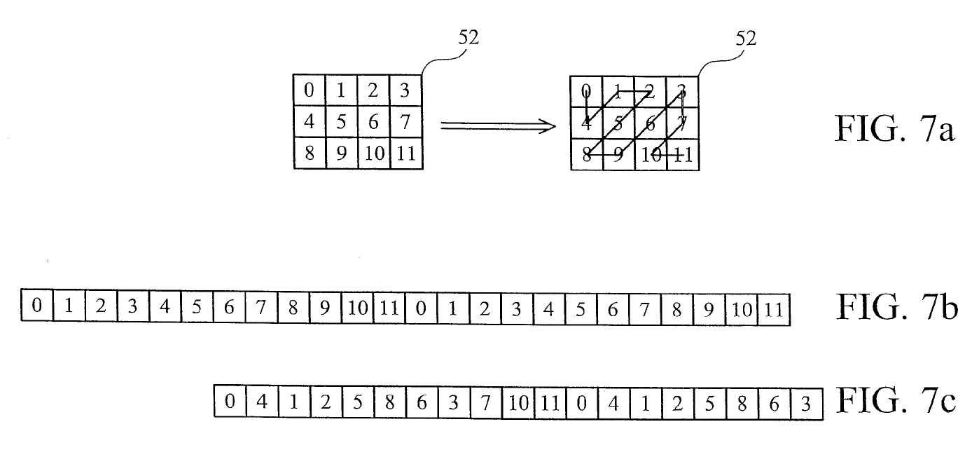

It is assumed that the image buffer 52 is a 3×4 buffer. Referring to FIG. 7a, 12 data sets (M=12) are written into the image buffer 52 at the horizontal scanning path 60. The data sets D0 to D11 are sequentially written into the image buffer 52, as shown in FIG. 7b. After the data sets D0 to D5 are written into the image buffer 52, the first buffer controller 53 begins to read the 12 data sets from the image buffer 52 at the zig-zag scanning path 61. The order of the data sets is shown in FIG. 7c. According to FIGS. 7b and 7c, without wasting time for isolating the reading and writing operation of the image buffer 52 or adopting double size buffers, the tearing effect can be easily prevented.

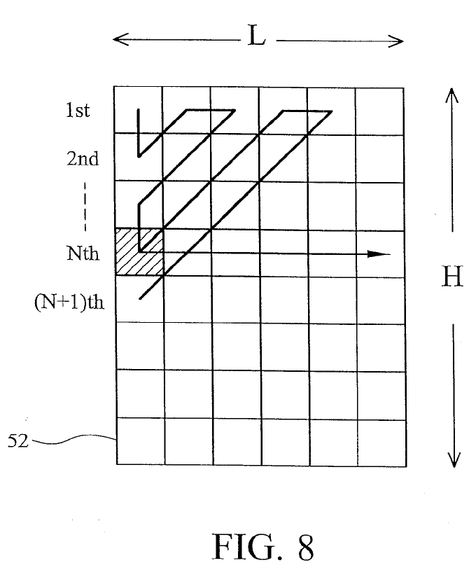

In some embodiments, after at least predetermined number of data sets among the M data sets written into the image buffer 52 at the horizontal scanning path 60, the first buffer controller 53 begins to read the data sets from the image buffer 52 from the starting point P1 at the zig-zag scanning path 61. It is assumed that image buffer 52 comprises a plurality of cells formed by intersecting H horizontal lines and L vertical lines, and the operation of writing at the horizontal scanning path 60 meets the operation of reading at the zig-zag scanning path 61 in the Nth horizontal line among the H horizontal lines, as shown in FIG. 8, wherein N is an integer number. From the Nth horizontal line to the (N+1)th horizontal line, the operation of writing at the horizontal scanning path 60 takes L unit time, and the operation of reading at the zig-zag scanning path 61 takes (2N+1) unit time. In order to avoid that the operation of reading at the zig-zag scanning path 61 overtakes the operation of writing at the horizontal scanning path 60, it has to satisfy the inequality (2N+1)>1, and the inequality N>(L−1)/2 is obtained.

The operation of writing at the horizontal scanning path 60 from the 1st horizontal line to the (N+1)th horizontal line takes N*L unit time, and the operation of reading at the zig-zag scanning path 61 from the 1st horizontal line to the (N+1)th horizontal line takes N(N+1)/2 unit time. Thus, after at least [NL−N(N+1)/2] data sets among the M data sets are written into the image buffer 52 at the horizontal scanning path 60, the first buffer controller 53 begins to read the data sets from the image buffer 52 from the starting point P1 at the zig-zag scanning path 61, and the operation of writing at the horizontal scanning path 60 can meet the operation of reading at the zig-zag scanning path 61 in the Nth horizontal line and is not overtook by the operation of reading at the zig-zag scanning path 61. In other words, the predetermined number is equal to [NL−N(N+1)/2].

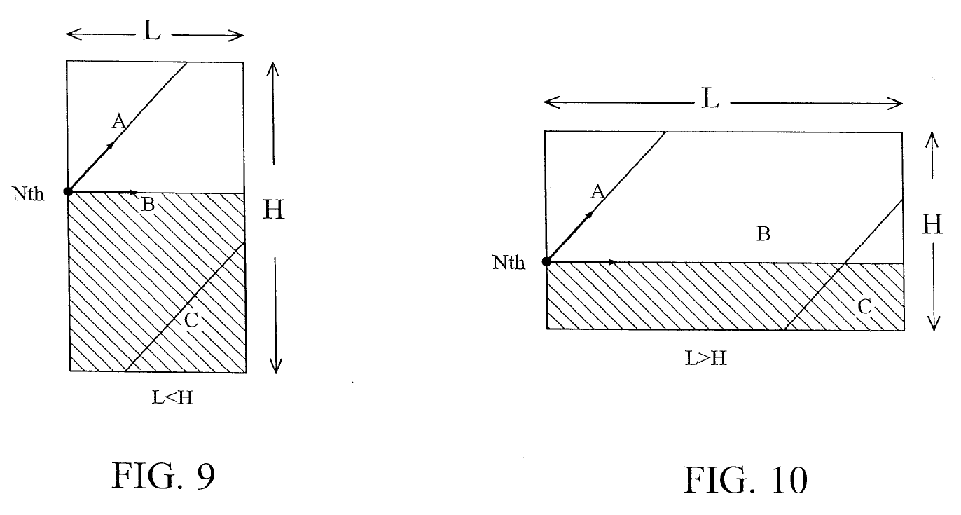

For the further consideration, the predetermined number is changed as the ratio of H and L. In the case that L is smaller than H, as shown in FIG. 9, the image buffer 52 is divided into three regions A, C, and B. From the one horizontal line to the next horizontal line in the region B, the operation of reading at the zig-zag scanning path 61 takes longer time than the operation of writing at the horizontal scanning path 60. From the one horizontal line to the next horizontal line in the region C, the time taken by the operation of reading at the zig-zag scanning path 61 is decreased gradually. When it is desired that the operation of writing at the horizontal scanning path 60 is not overtook by the operation of reading at the zig-zag scanning path 61 after the Nth horizontal line, the area of the slash area has to be smaller than the area of the region B:

(H−N)L<[(H−N)+H]L/2 (Inequality 1)

Inequality 1 is simplified to obtain the inequality N<2N. Since N is positive, the Inequality 1 is always conformed.

In the case that L is greater than H, as shown in FIG. 10, the image buffer 52 is also divided into three regions A, C, and B. From the one horizontal line to the next horizontal line in the region B, the operation of reading at the zig-zag scanning path 61 takes shorter time than the operation of writing at the horizontal scanning path 60. When it is desired that the operation of writing at the horizontal scanning path 60 is not overtook by the operation of reading at the zig-zag scanning path 61 after the Nth horizontal line, the area of the slash area has to be smaller than the area of the region B:

(H−N)L<[(L−H)+L]/2 (Inequality 2)

Inequality 2 is simplified to obtain the inequality N<(Ĥ2)/2L.

In a summary according to the above descriptions, when L is smaller than H, the value of N is obtained according to N>=(L−1)/2, and then the predetermined number is obtained by calculating [NL−N(N+1)/2] with the obtained value of N. When L is larger than H, the value of N is obtained according to N>=(L−1)/2 and N<(Ĥ2)/2L, and then the predetermined number is obtained by calculating [NL−N(N+1)/2] with the obtained value of N.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for accessing a memory buffer with H horizontal lines and L vertical lines, comprising:
writing M data sets into a memory buffer at a line scanning path; and
reading the M data sets from the memory buffer at a zig-zag scanning path.

2. The method as claimed in claim 1, wherein the line scanning path is implemented in a horizontal direction or in a vertical direction.

3. The method as claimed in claim 1, wherein the step of reading the M data sets begins after at least predetermined number of data sets among the M data sets are written into the memory buffer.

4. The method as claimed in claim 3, wherein the predetermined number is equal to M/2.

5. The method as claimed in claim 3, wherein when L is smaller than H, the predetermined number is equal to (NL−N(N−1)/2), where N>=(L−1)/2, N is an integer number.

6. The method as claimed in claim 3, wherein when L is greater than H, the predetermined number is equal to (NL−N(N−1)/2), where N>=(L−1)/2 and N>(Ĥ2)/2L, N is an integer number.

7. An image displaying method, comprising:
providing an input image;
writing M data sets of the input image into a first memory buffer with H horizontal lines and L vertical lines at a first line scanning path;
reading the M data sets from the first memory buffer at a first zig-zag scanning path to serve as a read-out sequence of data sets;
writing the read-out sequence of data sets into to a second memory buffer at a second zig-zag scanning path; and
reading the read-out sequence of data sets from the second memory buffer at a second line scanning path to display the input image.

8. The image displaying method as claimed in claim 7, wherein the first line scanning path is implemented in a horizontal direction or in a vertical direction.

9. The image displaying method claimed in claim 7, wherein the second line scanning path is implemented in a horizontal direction or in a vertical direction.

10. The image displaying method claimed in claim 7, wherein the step of reading the M data sets from the first memory buffer begins after at least predetermined number of data sets among the M data sets are written into the first memory buffer.

11. The image displaying method as claimed in claim 10, wherein the predetermined number is equal to M/2.

12. The image displaying method as claimed in claim 10, wherein when L is smaller than H, the predetermined number is equal to (NL−N(N−1)/2), where N>=(L−1)/2, N is an integer number.

13. The image displaying method as claimed in claim 10, wherein when L is greater than H, the predetermined number is equal to (NL−N(N−1)/2), where N>=(L−1)/2 and N>(Ĥ2)/2L, N is an integer number.

14. The image displaying method claimed in claim 7, wherein the input image is displayed in a rotating form.

15. An image display system for displaying an input image, comprising:
a data generator for generating M data sets of the input image;
a first memory buffer with H horizontal lines and L vertical lines, storing the M data sets from the data generator, wherein the M data sets are written into the first memory buffer at a first line scanning path;
a first buffer controller for reading the M data sets from the first memory buffer at a first zig-zag scanning path to serve as a read-out sequence of data sets; and
a display module receiving the read-out sequence of data sets from the first controller and displaying the input image according to the read-out sequence of data sets.

16. The image display system claimed in claim 15, wherein the display module comprising:
a second buffer controller for receiving the read-out sequence of data sets;
a second memory buffer for storing the read-out sequence of data sets from the second buffer controller, wherein the read-out sequence of data sets is written into the second memory buffer at a second zig-zag scanning path;
a display controller for reading the read-out sequence of data sets from the second memory buffer at a second line scanning path and generating a plurality of control signals;
a plurality of drivers for receiving the control signals and the read-out sequence of data sets; and
a display panel driven by the drives according to the control signals and the read-out sequence of data sets and displaying the input image.

17. The image display system claimed in claim 16, wherein the first and second buffer controllers can be integrated to be a controller.

18. The image display system claimed in claim 16 further comprising a interface coupled between the first and second buffer controllers.

19. The image display system claimed in claim 15, wherein the first buffer controller begins to read the M data sets from the first memory buffer begins after at least predetermined number of data sets among the M data sets are written into the first memory buffer.

20. The image display system claimed in claim 19, wherein the predetermined number is equal to M/2.

21. The image display system claimed in claim 19, wherein when L is smaller than H, the predetermined number is equal to (NL−N(N−1)/2), where N>=(L−1)/2, N is an integer number.

22. The image display system claimed in claim 19, wherein when L is greater than H, the predetermined number is equal to (NL−N(N−1)/2), where N>=(L−1)/2 and N>(Ĥ2)/2L, N is an integer number.

23. The image display system claimed in claim 15, wherein the input image is displayed in a rotating form.
